(19) United States
(12) Patent Application Publication
(10) Pub. No.: US 2026/0134619 A1
(43) Pub. Date: May 14, 2026

(54) UNSUPERVISED JOINT TRAINING OF MULTIMODAL PERCEPTION MODELS USING CURVATURE-BASED SAMPLING

(71) Applicant: GM Cruise Holdings, LLC, San Francisco, CA (US)

(72) Inventors: Runjian Chen, New Haven, CT (US); Hang Zhang, San Carlos, CA (US); Avinash Aghoram Ravichandran, Seattle, WA (US)

(73) Assignee: GM Cruise Holdings, LLC, San Francisco, CA (US)

(21) Appl. No.: 19/328,059

(22) Filed: Sep. 12, 2025

Related U.S. Application Data
(60) Provisional application No. 63/720,113, filed on Nov. 13, 2024.

(51) Int. Cl. G06T 17/00; B60W 10/04; B60W 10/18; B60W 10/20; B60W 60/00; G06T 7/521; G06T 7/55; G06T 7/64

(52) U.S. Cl. CPC G06T 17/00; B60W 60/00272; G06T 7/521; G06T 7/55; G06T 7/64; B60W 10/04; B60W 10/18; B60W 10/20; B60W 2420/408; G06T 2207/10024; G06T 2207/10028; G06T 2207/20081; G06T 2207/20084; G06T 2207/30252

(57) ABSTRACT

A method includes obtaining Light Detection and Ranging (LIDAR) feature embeddings and obtaining camera feature embeddings. The method includes generating fusion feature embeddings by fusing the LIDAR feature embeddings and the camera feature embeddings. The method includes determining sampling weights for a plurality of points in a three-dimensional (3D) scene. The method includes selecting a subset of the plurality of points based on the sampling weights. The method includes determining a rendering loss by performing differentiable rendering on the selected subset of points. The method includes determining a prototype learning loss by comparing the LIDAR feature embeddings and the camera feature embeddings to a set of learnable prototypes representing parts of the 3D scene in a shared feature space. The method includes jointly training a LIDAR encoder, a camera encoder, and a fusion encoder based on the rendering loss and the prototype learning loss.

### CROSS-REFERENCE TO RELATED APPLICATION

This U.S. patent application claims priority under 35 U.S.C. § 119(e) to U.S. Provisional Application 63/720,113, filed on Nov. 13, 2024. The disclosure of this prior application is considered part of the disclosure of this application and is hereby incorporated by reference in its entirety.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to computer-implemented systems for three-dimensional (3D) perception, and more specifically to training machine learning models for sensor fusion applications. Vehicles and other autonomous systems are often equipped with a suite of sensors to perceive their surrounding environment. These sensors may include cameras that capture two-dimensional (2D) images rich in color and texture, and Light Detection and Ranging (LIDAR) sensors that generate 3D point clouds providing precise spatial and geometric information. Perception systems may utilize machine learning models, such as deep neural networks, to process the data from these different sensor modalities. In some applications, data from both cameras and LIDAR are processed together to create a comprehensive representation of the 3D scene. The training of such models often involves learning to extract salient features from both the image data and the point cloud data to facilitate downstream perception tasks, such as object detection and scene understanding.

### SUMMARY

One aspect of the disclosure provides a computer-implemented method executed on data processing hardware that causes the data processing hardware to perform operations. The operations include obtaining, from a Light Detection and Ranging (LIDAR) encoder, LIDAR feature embeddings based on LIDAR data for a three-dimensional (3D) scene. The operations include obtaining, from a camera encoder, camera feature embeddings based on camera image data for the 3D scene. The operations include generating, using a fusion encoder, fusion feature embeddings by fusing the LIDAR feature embeddings and the camera feature embeddings. The operations include determining sampling weights for a plurality of points in the 3D scene based on a surface curvature estimated from the fusion feature embeddings. Points with higher curvature are assigned greater sampling weights. The operations include selecting a subset of the plurality of points based on the sampling weights. The operations include determining a rendering loss by performing differentiable rendering on the selected subset of points to reconstruct at least one of the LIDAR data or the camera image data. The operations include determining a prototype learning loss by comparing the LIDAR feature embeddings and the camera feature embeddings to a set of learnable prototypes representing parts of the 3D scene in a shared feature space. The operations include jointly training the LIDAR encoder, the camera encoder, and the fusion encoder based on the rendering loss and the prototype learning loss.

Implementations of the disclosure may include one or more of the following optional features. In some implementations, determining the sampling weights includes estimating a signed distance function (SDF) for the 3D scene based on the fusion feature embeddings and determining the surface curvature based on a derivative of the SDF. The prototype learning loss may include a swapping prediction loss that models an interaction between the LIDAR data and the camera image data. Here, the operations may further include determining a first similarity score between the LIDAR feature embeddings and the set of learnable prototypes, determining a second similarity score between the camera feature embeddings and the set of learnable prototypes, and performing a cross-model prediction using the first similar score and the second similarity score.

In some examples, the prototype learning loss includes a gram matrix regularization loss that prevents collapse of the set of learnable prototypes by promoting diversity among the set of learnable prototypes. In these examples, the operations may further include determining the gram matrix regularization loss by minimizing non-diagonal elements of a gram matrix determined from the set of learnable prototypes. The operations may further include deploying a 3D perception model to a vehicle, the 3D perception model including the LIDAR encoder, the camera encoder, and the fusion encoder after joint training. The 3D perception model, when deployed to the vehicle, is configured to cause the vehicle to process real-time sensor data from one or more sensors of the vehicle and control a maneuver of the vehicle based on processing the real-time sensor data. Here, the control of the maneuver of the vehicle may include generating a control signal to actuate at least one of a steering system, a braking system, or an acceleration system of the vehicle. In some implementations, the operations further include projecting the LIDAR feature embeddings and the camera feature embeddings into the shared feature space using one or more projection heads prior to determining the prototype learning loss. The rendering loss may include at least one of a range prediction loss for the LIDAR data, a color prediction loss for the camera image data, or a surface signed distance function loss.

Another aspect of the disclosure provides a vehicle that includes data processing hardware and memory hardware storing instructions that when executed on the data processing hardware causes the data processing hardware to perform operations. The operations include obtaining, from a Light Detection and Ranging (LIDAR) encoder, LIDAR feature embeddings based on LIDAR data for a three-dimensional (3D) scene. The operations include obtaining, from a camera encoder, camera feature embeddings based on camera image data for the 3D scene. The operations include generating, using a fusion encoder, fusion feature embeddings by fusing the LIDAR feature embeddings and the camera feature embeddings. The operations include determining sampling weights for a plurality of points in the 3D scene based on a surface curvature estimated from the fusion feature embeddings. Points with higher curvature are assigned greater sampling weights. The operations include selecting a subset of the plurality of points based on the sampling weights. The operations include determining a rendering loss by performing differentiable rendering on the selected subset of points to reconstruct at least one of the LIDAR data or the camera image data. The operations include determining a prototype learning loss by comparing the LIDAR feature embeddings and the camera feature embeddings to a set of learnable prototypes representing parts of the 3D scene in a shared feature space. The operations include jointly training the LIDAR encoder, the camera encoder, and the fusion encoder based on the rendering loss and the prototype learning loss.

Implementations of the disclosure may include one or more of the following optional features. In some implementations, determining the sampling weights includes estimating a signed distance function (SDF) for the 3D scene based on the fusion feature embeddings and determining the surface curvature based on a derivative of the SDF. The prototype learning loss may include a swapping prediction loss that models an interaction between the LIDAR data and the camera image data. Here, the operations may further include determining a first similarity score between the LIDAR feature embeddings and the set of learnable prototypes, determining a second similarity score between the camera feature embeddings and the set of learnable prototypes, and performing a cross-model prediction using the first similar score and the second similarity score.

In some examples, the prototype learning loss includes a gram matrix regularization loss that prevents collapse of the set of learnable prototypes by promoting diversity among the set of learnable prototypes. In these examples, the operations may further include determining the gram matrix regularization loss by minimizing non-diagonal elements of a gram matrix determined from the set of learnable prototypes. The operations may further include deploying a 3D perception model to a vehicle, the 3D perception model including the LIDAR encoder, the camera encoder, and the fusion encoder after joint training. The 3D perception model, when deployed to the vehicle, is configured to cause the vehicle to process real-time sensor data from one or more sensors of the vehicle and control a maneuver of the vehicle based on processing the real-time sensor data. Here, the control of the maneuver of the vehicle may include generating a control signal to actuate at least one of a steering system, a braking system, or an acceleration system of the vehicle. In some implementations, the operations further include projecting the LIDAR feature embeddings and the camera feature embeddings into the shared feature space using one or more projection heads prior to determining the prototype learning loss. The rendering loss may include at least one of a range prediction loss for the LIDAR data, a color prediction loss for the camera image data, or a surface signed distance function loss.

Another aspect of the disclosure provides a computer-readable medium having instructions that, when executed by data processing hardware, causes the data processing hardware to perform operations. The operations include obtaining, from a Light Detection and Ranging (LIDAR) encoder, LIDAR feature embeddings based on LIDAR data for a three-dimensional (3D) scene. The operations include obtaining, from a camera encoder, camera feature embeddings based on camera image data for the 3D scene. The operations include generating, using a fusion encoder, fusion feature embeddings by fusing the LIDAR feature embeddings and the camera feature embeddings. The operations include determining sampling weights for a plurality of points in the 3D scene based on a surface curvature estimated from the fusion feature embeddings. Points with higher curvature are assigned greater sampling weights. The operations include selecting a subset of the plurality of points based on the sampling weights. The operations include determining a rendering loss by performing differentiable rendering on the selected subset of points to reconstruct at least one of the LIDAR data or the camera image data. The operations include determining a prototype learning loss by comparing the LIDAR feature embeddings and the camera feature embeddings to a set of learnable prototypes representing parts of the 3D scene in a shared feature space. The operations include jointly training the LIDAR encoder, the camera encoder, and the fusion encoder based on the rendering loss and the prototype learning loss.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system of a three-dimensional perception model being deployed on a vehicle.

FIG. 2 is a schematic view of an example training process for training the three-dimensional perception model.

FIG. 3 is a flowchart of an exemplary arrangement of operations for a computer-implemented method of training the three-dimensional perception model.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Three-dimensional (3D) perception is an important component of many autonomous systems, including self-driving vehicles, robotics, and augmented reality platforms. These systems rely on an accurate and robust understanding of their surrounding environment to navigate and interact safely and effectively. To achieve this understanding, such systems are typically equipped with a variety of sensors, such as cameras and Light Detection and Ranging (LIDAR) sensors. By fusing the data from these different sensor modalities, a perception model may leverage the rich, semantic information from camera images and the precise geometric structure from LIDAR point clouds to create a more comprehensive and reliable representation of the 3D scene.

Training the machine learning models that power these fusion-based perception systems presents a significant challenge. The prevailing training paradigm, supervised learning, requires large-scale datasets containing vast amounts of sensor data that have been meticulously labeled with ground-truth annotations. For 3D perception tasks, this involves annotating objects with precise 3D bounding boxes and class labels across millions of data frames. The process of generating these high-quality 3D labels is exceptionally time-consuming, labor-intensive, and requires significant financial investment, creating a substantial bottleneck in the development and improvement of perception models.

To mitigate the dependency on massive labeled datasets, unsupervised pre-training has emerged as a promising approach. In this paradigm, a model is first pre-trained on large quantities of readily available, unlabeled sensor data. During this phase, the model learns to extract general and meaningful feature representations of the environment. Subsequently, the pre-trained model may be fine-tuned for a specific downstream task, such as 3D object detection, using a much smaller amount of labeled data. This two-stage process may significantly improve model performance and reduce the overall data labeling burden. However, applying unsupervised pre-training to multimodal fusion models introduces distinct computational challenges. The combined processing of high-dimensional data from both camera images and large-scale LIDAR point clouds simultaneously may be computationally prohibitive, particularly with respect to the memory capacity of graphics processing units (GPUs). A single instance of paired image and point cloud data may consume substantial memory, severely limiting the feasibility of processing this data jointly during the pre-training phase.

Due to these computational constraints, a shared practice is to perform pre-training for each sensor modality separately. For instance, the camera-specific components of a fusion model are pre-trained using only image data, while the LIDAR-specific components are pre-trained independently using only point cloud data. While this approach is computationally manageable, it fails to exploit the synergistic potential of the two modalities during the critical pre-training stage. The models are unable to learn the intricate correlations between visual semantics and 3D geometry, thereby limiting the quality of the learned feature representations and forgoing potential performance improvements in the final fusion model.

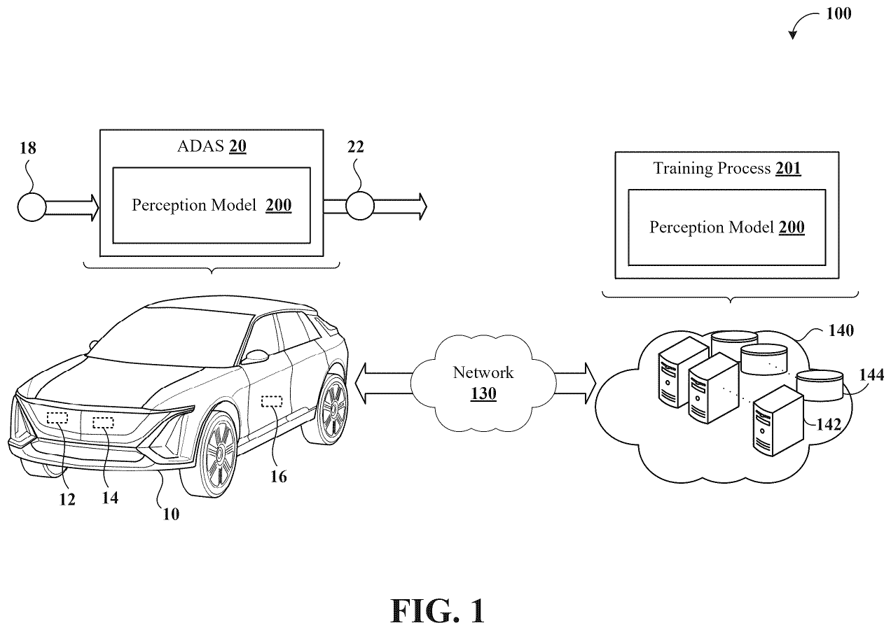

Referring now to FIG. 1, in some examples, a system 100 provides an operational environment for training and deploying a three-dimensional (3D) perception model 200. The system 100 includes a vehicle 10, which may be an autonomous vehicle, a semi-autonomous vehicle, or a vehicle equipped with an advanced driver-assistance system (ADAS) 20. The vehicle 10 includes data processing hardware 12 operatively coupled with memory hardware 14. For instance, the data processing hardware 12 may be one or more central processing units (CPUs), graphics processing units (GPUs), application-specific integrated circuits (ASICs), or field-programmable gate arrays (FPGAs). The memory hardware 14 may represent any form of non-transitory computer-readable media, such as random-access memory (RAM), read-only memory (ROM), or persistent storage like solid-state drives (SSDs).

The vehicle 10 may establish communication with a remote computing system 140 over a network 130. The network 130 may be any suitable communication network, for example, a cellular network (e.g., 4G LTE, 5G), a Wi-Fi network, or another wireless communication protocol. The remote computing system 140 provides a high-performance computing environment, which may be a cloud-based platform or a dedicated data center, suitable for computationally intensive tasks such as training machine learning models. The remote computing system 140 includes data processing hardware 142 in communication with memory hardware 144. The data processing hardware 142 may include computing resources, such as clusters of GPUs, designed to accelerate machine learning workflows. Similarly, the memory hardware 144 provides large-capacity storage for datasets and model parameters. In this configuration, the remote computing system 140 may execute a training process 201 for the 3D perception model 200 and subsequently deploy the trained 3D perception model 200 back to the vehicle 10 for real-time inference and operation.

The remote computing system 140 performs the training process 201 to train the 3D perception model 200. After the 3D perception model 200 is trained, the remote computing system 140 deploys the trained 3D perception model 200 to the vehicle 10. The vehicle 10 may be equipped with one or more sensors 16, such as camera systems and Light Detection and Ranging (LIDAR) systems, that produce a stream of real-time sensor data 18. For instance, a camera may generate image data, while a LIDAR sensor generates a point cloud. The vehicle 10 executes the ADAS 20 that uses the trained 3D perception model 200 to process the real-time sensor data 18. Based on processing the real-time sensor data 18, the ADAS 20 controls a maneuver of the vehicle 10. Controlling the maneuver of the vehicle 10 may include the ADAS 20 generating a control signal 22 to actuate at least one of a steering system, a braking system, or an acceleration system of the vehicle 10. For example, based on the 3D perception model 200 identifying a pedestrian from the real-time sensor data 18, the ADAS 20 may generate a control signal 22 to actuate the braking system to slow or stop the vehicle 10. As another example, the ADAS 20 may generate the control signal 22 to actuate the steering system to alter the path of the vehicle 10 to navigate around a detected obstacle. The control signal 22 may also actuate the acceleration system to adjust the speed of the vehicle 10 in response to changing traffic conditions identified from the sensor data 18.

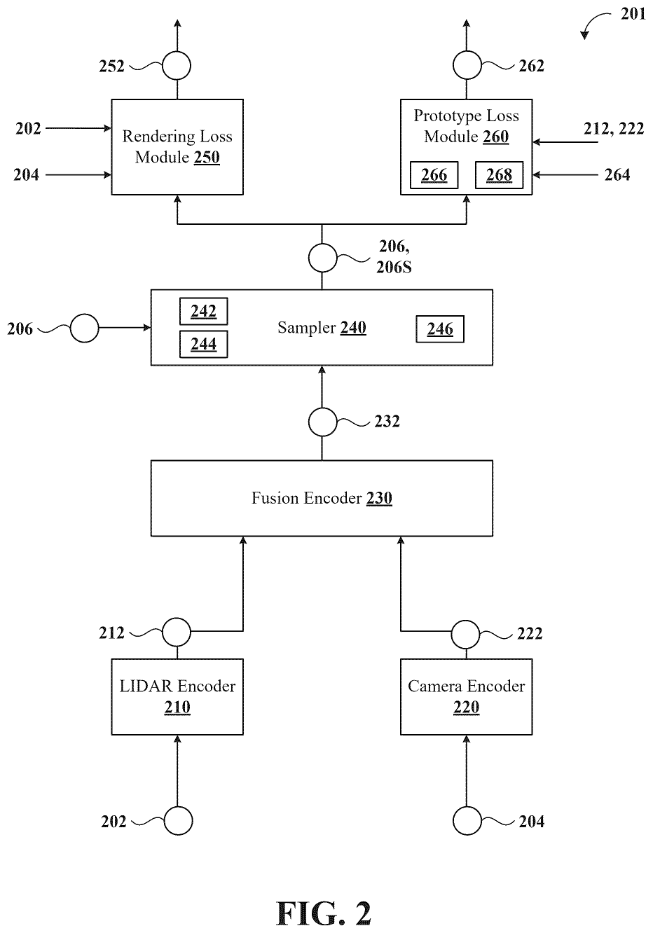

Referring now to FIG. 2, in some implementations, the training process 201 executes operations to train the 3D perception model 200, which may be a neural network architecture configured for sensor fusion. The 3D perception model 200 may include multiple components, such as a LIDAR encoder 210, a camera encoder 220, and a fusion encoder 230. Each of these encoders may be implemented as a distinct neural network, or as parts of a larger, integrated network architecture. The LIDAR encoder 210 processes LIDAR data 202 for a three-dimensional (3D) scene. The LIDAR data 202, for example, may be a point cloud that contains a set of data points in 3D space, where each point has coordinates (x, y, z) and potentially other attributes, such as intensity. The LIDAR encoder 210 processes the raw or pre-processed point cloud data to generate LIDAR feature embeddings 212. The LIDAR feature embedding 212 is a compact, lower-dimensional representation that captures the salient geometric and structural characteristics of the 3D scene as perceived by the LIDAR sensor.

Similarly, the camera encoder 220, which may be a distinct neural network such as a Swin Transformer, processes camera image data 204 for the same 3D scene. The camera image data 204 may be a set of images captured by one or more cameras mounted on the vehicle 10, for instance, providing different perspectives of the surrounding environment. The camera encoder 220 extracts visual features from these images, such as textures, colors, and object shapes. Using camera calibration and projection information, the camera encoder 220 may project these two-dimensional visual features into the 3D space of the scene to generate camera feature embeddings 222. The camera feature embedding 222 is a dense, high-dimensional vector that encapsulates the semantic information present in the camera images, contextualized within the 3D geometry of the scene.

The fusion encoder 230 receives, as input, both the LIDAR feature embeddings 212 and the camera feature embeddings 222. In some examples, the fusion encoder 230 concatenates the LIDAR feature embeddings 212 and the camera feature embeddings 222 along a feature dimension to form a combined set of feature embeddings. The fusion encoder 230 then processes the combined set of feature embeddings to generate the fusion feature embeddings 232. The fusion feature embeddings 232 represent a rich, multimodal representation of the 3D scene, integrating the precise geometric information from the LIDAR feature embeddings 212 with the detailed semantic and textural information from the camera feature embeddings 222. The fusion encoder 230 may be implemented, for example, as one or more convolutional layers or another type of neural network layer configured to effectively merge and process the features from the different sensor modalities.

To facilitate the joint training of the LIDAR encoder 210, the camera encoder 220, and the fusion encoder 230 in a computationally efficient manner, the training process 201 employs a sampler 240. The sampler 240 determines sampling weights 242 for a plurality of points 206 in the 3D scene. The sampling weights 242 are determined based on a surface curvature 244, which the sampler 240 estimates from the fusion feature embeddings 232. The process of determining sampling weights 242 prioritizes points 206 that are more informative for reconstructing the scene geometry. For example, points 206 located on surfaces with higher surface curvature 244, such as the edges of a vehicle 10 or the corners of a building, are assigned greater sampling weights 242. Conversely, points on surfaces with lower surface curvature 244, such as a flat road surface, are assigned smaller sampling weights 242. This approach focuses the computational resources of the training process 201 on the most geometrically complex and informative regions of the 3D scene.

In some examples, the sampler 240 determines the sampling weights 242 through a multi-step process. First, the sampler 240 estimates a signed distance function (SDF) 246 for the 3D scene based on the fusion feature embeddings 232. The SDF 246 represents the shortest distance from any given point in the 3D scene to a surface, with the sign indicating whether the point is inside or outside the surface. Second, the sampler 240 determines the surface curvature 244 by determining a derivative of the SDF 246. For instance, a second-order derivative, such as the Laplacian, may be determined from the SDF 246 to estimate the curvature at various locations within the 3D scene. The magnitude of this derivative at each of the plurality of points 206 then serves as the basis for the corresponding sampling weight 242.

Subsequently, the sampler 240 executes a selection process to generate a subset of the plurality of points 206, 206S from the initial plurality of points 206. This selection is performed based on the calculated sampling weights 242, which act as a probability distribution for the selection. In some implementations, the sampler 240 may utilize a multinomial sampling technique. In such a technique, each point 206 from the plurality of points 206 has a probability of being selected that is proportional to the corresponding sampling weight 242 of the point 206. For example, a point 206 located on a sharp corner of an object, having a high surface curvature 244 and thus a large sampling weight 242, has a higher probability of being included in the subset of points 206S compared to a point on a flat road surface with a low sampling weight 242. Such strategic selection ensures that the subset of points 206S is densely populated with geometrically significant points, thereby enabling a more efficient and accurate reconstruction during the subsequent differentiable rendering step while managing computational load. The size of the selected subset of points 206S may be a configurable parameter, allowing a trade-off between computational efficiency and reconstruction fidelity.

The training process 201 further utilizes a rendering loss module 250 to supervise the training of the LIDAR encoder 210, the camera encoder 220, and the fusion encoder 230. The rendering loss module 250 determines a rendering loss 252 by executing a differentiable rendering operation on the selected subset of points 206S. This operation aims to reconstruct the original sensor inputs, specifically at least one of the LIDAR data 202 or the camera image data 204, from the learned fusion feature embeddings 232. By comparing the reconstructed data with the ground-truth sensor data (e.g., the LIDAR data 202 or the camera image data 204), the rendering loss 252 quantifies the accuracy of the 3D scene representation learned by the 3D perception model 200.

In some implementations, the rendering loss 252 is a composite loss function that includes several components, each targeting a different aspect of the scene reconstruction. For example, the rendering loss 252 may include a range prediction loss for the LIDAR data 202. The range prediction loss measures the discrepancy between the rendered depth or range values for the selected subset of points 206S and the actual range measurements recorded in the LIDAR data 202. As another example, the rendering loss 252 may include a color prediction loss for the camera image data 204. The color prediction loss evaluates the difference between the rendered color values (e.g., RGB values) for the selected subset of points 206S and the corresponding pixel colors in the original camera image data 204. Moreover, the rendering loss 252 may incorporate a surface signed distance function loss. This loss component encourages the underlying learned representation, such as the SDF 246, to accurately model the surfaces of objects in the 3D scene by penalizing deviations from a zero-distance value at points known to be on a surface. By minimizing the rendering loss 252, the training process 201 guides the 3D perception model 200 to learn fusion feature embeddings 232 that are not only descriptive but also geometrically and photometrically consistent with the observed 3D scene.

The training process 201 further employs a prototype loss module 260 that determines a prototype learning loss 262. The prototype learning loss 262 is determined by comparing the LIDAR feature embeddings 212 and the camera feature embeddings 222 to a set of learnable prototypes 264. The set of learnable prototypes 264 represents various parts or semantic segments of the 3D scene within a shared feature space, which acts as a bridge between the two sensor modalities. For example, individual learnable prototypes 264 within the set of learnable prototypes 264 may correspond to abstract representations of objects like vehicles, pedestrians, or sections of the road plane.

In some examples, the prototype learning loss 262 includes a swapping prediction loss 266. The swapping prediction loss 266 is specifically designed to model and learn from the interaction between the geometric information from the LIDAR data 202 and the semantic information from the camera image data 204. To determine the swapping prediction loss 266, the prototype loss module 260 executes a series of operations. First, the prototype loss module 260 determines a first similarity score by determining the similarity between the LIDAR feature embeddings 212 and the set of learnable prototypes 264. The first similarity score quantifies how well each feature embedding from the LIDAR data 202 aligns with each of the learnable prototypes 264. Concurrently or sequentially, the prototype loss module 260 determines a second similarity score between the camera feature embeddings 222 and the set of learnable prototypes 264. The second similarity score quantifies how well each feature embedding from the camera image data 204 aligns with each of the learnable prototypes 264. Thereafter, the prototype loss module 260 performs a cross-modal prediction. For example, the prototype loss module 260 may use the assignments derived from the first similarity score (LIDAR-to-prototype) to predict the similarity scores for the camera feature embeddings 222, and conversely, use the assignments from the second similarity score (camera-to-prototype) to predict the similarity scores for the LIDAR feature embeddings 212. This cross-prediction process encourages the LIDAR encoder 210 and the camera encoder 220 to learn features that are consistent across both sensor modalities for corresponding parts of the 3D scene.

In some implementations, the prototype learning loss 262 includes a gram matrix regularization loss 268. The gram matrix regularization loss 268 is a computational mechanism designed to prevent a potential training failure mode known as prototype collapse. Prototype collapse occurs when the optimization process causes multiple, or even all, of the vectors in the set of learnable prototypes 264 to converge to similar or identical values. Should such a collapse occur, the ability of the set of learnable prototypes 264 to represent distinct parts of the 3D scene would be diminished, thereby degrading the quality of the learned feature representations. To counteract this, the gram matrix regularization loss 268 actively promotes diversity among the vectors within the set of learnable prototypes 264.

To achieve this promotion of diversity, the prototype loss module 260 determines the gram matrix regularization loss 268 by first determining a gram matrix from the set of learnable prototypes 264. The gram matrix is a square matrix where each element represents the inner product of two vectors from a given set. In this context, the diagonal elements of the gram matrix correspond to the inner product of each prototype vector with itself, while the non-diagonal elements represent the inner product, or similarity, between distinct pairs of prototype vectors. The prototype loss module 260 then formulates the gram matrix regularization loss 268 as a function that penalizes large values in the non-diagonal elements of the gram matrix. By minimizing the non-diagonal elements, the training process 201 is incentivized to adjust the learnable prototypes 264 to be less similar to one another, effectively pushing them apart in the shared feature space and maintaining a diverse set of representations.

To align the LIDAR feature embeddings 212 and the camera feature embeddings 222 for comparison against the set of learnable prototypes 264, the prototype loss module 260 first transforms both sets of embeddings into the shared feature space. The shared feature space is a shared, lower-dimensional space where features from different modalities may be directly compared. To perform this transformation, the prototype loss module 260 utilizes one or more projection heads. For example, a first projection head may process the LIDAR feature embeddings 212, and a second projection head may process the camera feature embeddings 222. Each projection head may be implemented as a neural network, for instance, a Multi-Layer Perceptron (MLP), that is specifically trained to map the high-dimensional input embeddings to the dimensionality of the shared feature space. After applying the projection heads, the resulting projected embeddings for both LIDAR and camera data share the same vector dimensions as the learnable prototypes 264, enabling subsequent similarity calculations and the determination of the prototype learning loss 262.

The training process 201 executes an optimization procedure, such as stochastic gradient descent or a variant thereof, to jointly update the parameters of the LIDAR encoder 210, the camera encoder 220, and the fusion encoder 230. The joint training is guided by a total loss function that is a weighted sum of the rendering loss 252 and the prototype learning loss 262. The rendering loss 252 provides a supervisory signal based on the ability of the 3D perception model 200 to reconstruct the scene geometry and appearance, encouraging the encoders to learn features that are photometrically and geometrically consistent with the sensor data. Concurrently, the prototype learning loss 262 provides a supervisory signal that encourages the LIDAR encoder 210 and the camera encoder 220 to learn feature embeddings that are semantically aligned and consistent across the different sensor modalities. By minimizing both losses simultaneously, the training process 201 optimizes the entire 3D perception model 200 end-to-end, enabling the model to learn a comprehensive and robust multimodal representation of the 3D scene that effectively integrates information from both the LIDAR data 202 and the camera image data 204.

Once the joint training is complete, the resulting trained 3D perception model 200 may be deployed for real-time inference, for instance, in the vehicle 10. For inference operations, the core components of the 3D perception model 200, including the LIDAR encoder 210, the camera encoder 220, and the fusion encoder 230, are utilized. These components process live sensor data to generate the fusion feature embeddings 232, which serve as the basis for downstream perception tasks like object detection or scene segmentation. Components related to the training supervision, such as the sampler 240, the rendering loss module 250, and the prototype loss module 260, are not used during inference. These training-specific modules, including the learnable prototypes 264 and the mechanisms for calculating the rendering loss 252 and the prototype learning loss 262, may be omitted from the deployed model to create a more computationally efficient and streamlined architecture suitable for real-time execution.

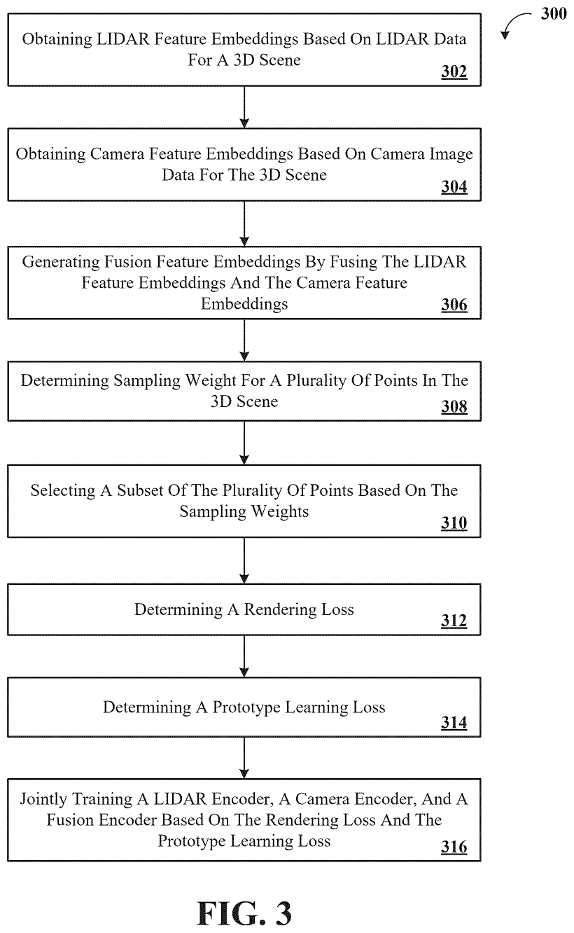

FIG. 3 is a flowchart of an exemplary arrangement of operations for a computer-implemented method 300 for training a 3D perception model 200. At operation 302, the method 300 includes obtaining, from a LIDAR encoder 210, LIDAR feature embeddings 212 based on LIDAR data 202 for a 3D scene. At operation 304, the method 300 includes obtaining, from a camera encoder 220, camera feature embeddings 222 based on camera image data 204 for the 3D scene. At operation 306, the method 300 includes generating, using a fusion encoder 230, fusion feature embeddings 232 by fusing the LIDAR feature embeddings 212 and the camera feature embeddings 222. At operation 308, the method 300 includes determining sampling weights 242 for a plurality of points 206 in the 3D scene based on a surface curvature 244 estimated from the fusion feature embeddings 232. Points 206 with higher surface curvature 244 are assigned greater sampling weights 242. At operation 310, the method 300 includes selecting a subset of the plurality of points 206, 206S based on the sampling weights 242. At operation 312, the method 300 includes determining a rendering loss 252 by performing differentiable rendering on the selected subset of points 206S to reconstruct at least one of the LIDAR data 202 or the camera image data 204. At operation 314, the method 300 includes determining a prototype learning loss 262 by comparing the LIDAR feature embeddings 212 and the camera feature embeddings 222 to a set of learnable prototypes 264 representing parts of the 3D scene in a shared feature space. At operation 316, the method 300 includes jointly training the LIDAR encoder 210, the camera encoder 220, and the fusion encoder 230 based on the rendering loss 252 and the prototype learning loss 262.

Thus, the training process 201 provides a computationally efficient framework for jointly pre-training the 3D perception model 200, which addresses technical challenges associated with processing large volumes of high-dimensional sensor data. By implementing a curvature-based sampling strategy, the training process 201 may selectively focus computational resources on geometrically informative regions of a 3D scene. This selective processing enables the joint training of LIDAR and camera encoders on paired sensor data, a task that may be computationally prohibitive using uniform sampling methods due to high memory consumption on data processing hardware such as GPUs. This approach facilitates the learning of feature embeddings that capture the synergistic relationship between geometric structure from LIDAR and semantic content from camera images, leading to a more robust and comprehensive scene representation.

Notably, the training process 201 integrates a prototype learning scheme to explicitly model the interaction between the different sensor modalities. This is achieved by establishing a shared feature space with a set of learnable prototypes 264 that represent parts of the 3D scene. A swapping prediction loss encourages the LIDAR encoder 210 and the camera encoder 220 to produce semantically consistent feature embeddings for corresponding scene elements, thereby aligning their respective representations. Moreover, a gram matrix regularization loss is introduced to maintain diversity among the learnable prototypes 264, which prevents a shared training failure mode known as prototype collapse and ensures that the 3D perception model 200 learns a rich and varied set of feature representations.

The combination of curvature-based sampling for computational efficiency and a dual-loss prototype learning mechanism for cross-modal feature alignment provides a technical solution for effective unsupervised pre-training of sensor fusion models. The rendering loss 252 guides the 3D perception model 200 to learn a geometrically and photometrically accurate representation of the scene, while the prototype learning loss 262 ensures that the representations from different sensors are semantically coherent. Jointly optimizing these objectives allows the system to learn powerful, generalizable features from large amounts of unlabeled data, which can then be fine-tuned for improved performance on various downstream 3D perception tasks, such as object detection or scene segmentation, with a reduced dependency on extensively labeled datasets.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executed on data processing hardware that causes the data processing hardware to perform operations comprising:
obtaining, from a Light Detection and Ranging (LIDAR) encoder, LIDAR feature embeddings based on LIDAR data for a three-dimensional (3D) scene;
obtaining, from a camera encoder, camera feature embeddings based on camera image data for the 3D scene;
generating, using a fusion encoder, fusion feature embeddings by fusing the LIDAR feature embeddings and the camera feature embeddings;
determining sampling weights for a plurality of points in the 3D scene based on a surface curvature estimated from the fusion feature embeddings, wherein points with higher surface curvature are assigned greater sampling weights;
selecting a subset of the plurality of points based on the sampling weights;
determining a rendering loss by performing differentiable rendering on the selected subset of points to reconstruct at least one of the LIDAR data or the camera image data;
determining a prototype learning loss by comparing the LIDAR feature embeddings and the camera feature embeddings to a set of learnable prototypes representing parts of the 3D scene in a shared feature space; and
jointly training the LIDAR encoder, the camera encoder, and the fusion encoder based on the rendering loss and the prototype learning loss.

2. The method of claim 1, wherein determining the sampling weights comprises:
estimating a signed distance function (SDF) for the 3D scene based on the fusion feature embeddings; and
determining the surface curvature based on a derivative of the SDF.

3. The method of claim 1, wherein the prototype learning loss includes a swapping prediction loss that models an interaction between the LIDAR data and the camera image data.

4. The method of claim 3, wherein the operations further comprise:
determining a first similarity score between the LIDAR feature embeddings and the set of learnable prototypes;
determining a second similarity score between the camera feature embeddings and the set of learnable prototypes; and
performing a cross-model prediction using the first similarity score and the second similarity score.

5. The method of claim 1, wherein the prototype learning loss includes a gram matrix regularization loss that prevents collapse of the set of learnable prototypes by promoting diversity among the set of learnable prototypes.

6. The method of claim 5, wherein the operations further comprise determining the gram matrix regularization loss by minimizing non-diagonal elements of a gram matrix determined from the set of learnable prototypes.

7. The method of claim 1, wherein the operations further comprise:
after joint training, deploying a 3D perception model to a vehicle, the 3D perception model comprising the LIDAR encoder, the camera encoder, and the fusion encoder,
wherein the 3D perception model, when deployed to the vehicle, is configured to cause the vehicle to:
process real-time sensor data from one or more sensors of the vehicle; and
control a maneuver of the vehicle based on processing the real-time sensor data.

8. The method of claim 7, wherein the control of the maneuver of the vehicle comprises generating a control signal to actuate at least one of a steering system, a braking system, or an acceleration system of the vehicle.

9. The method of claim 1, wherein the operations further comprise projecting the LIDAR feature embeddings and the camera feature embeddings into the shared feature space using one or more projection heads prior to determining the prototype learning loss.

10. The method of claim 1, wherein the rendering loss comprises at least one of:
a range prediction loss for the LIDAR data;
a color prediction loss for the camera image data; or
a surface signed distance function loss.

11. A vehicle comprising:
data processing hardware; and
memory hardware in communication with the data processing hardware, the memory hardware storing instructions that when executed on the data processing hardware cause the data processing hardware to perform operations comprising:
obtaining, from a Light Detection and Ranging (LIDAR) encoder, LIDAR feature embeddings based on LIDAR data for a three-dimensional (3D) scene;
obtaining, from a camera encoder, camera feature embeddings based on camera image data for the 3D scene;
generating, using a fusion encoder, fusion feature embeddings by fusing the LIDAR feature embeddings and the camera feature embeddings;
determining sampling weights for a plurality of points in the 3D scene based on a surface curvature estimated from the fusion feature embeddings, wherein points with higher surface curvature are assigned greater sampling weights;
selecting a subset of the plurality of points based on the sampling weights;
determining a rendering loss by performing differentiable rendering on the selected subset of points to reconstruct at least one of the LIDAR data or the camera image data;
determining a prototype learning loss by comparing the LIDAR feature embeddings and the camera feature embeddings to a set of learnable prototypes representing parts of the 3D scene in a shared feature space; and
jointly training the LIDAR encoder, the camera encoder, and the fusion encoder based on the rendering loss and the prototype learning loss.

12. The vehicle of claim 11, wherein determining the sampling weights comprises:
estimating a signed distance function (SDF) for the 3D scene based on the fusion feature embeddings; and
determining the surface curvature based on a derivative of the SDF.

13. The vehicle of claim 11, wherein the prototype learning loss includes a swapping prediction loss that models an interaction between the LIDAR data and the camera image data.

14. The vehicle of claim 13, wherein the operations further comprise:
determining a first similarity score between the LIDAR feature embeddings and the set of learnable prototypes;
determining a second similarity score between the camera feature embeddings and the set of learnable prototypes; and
performing a cross-model prediction using the first similarity score and the second similarity score.

15. The vehicle of claim 11, wherein the prototype learning loss includes a gram matrix regularization loss that prevents collapse of the set of learnable prototypes by promoting diversity among the set of learnable prototypes.

16. The vehicle of claim 15, wherein the operations further comprise determining the gram matrix regularization loss by minimizing non-diagonal elements of a gram matrix determined from the set of learnable prototypes.

17. The vehicle of claim 11, wherein the operations further comprise:
after joint training, deploying a 3D perception model to the vehicle, the 3D perception model comprising the LIDAR encoder, the camera encoder, and the fusion encoder,
wherein the 3D perception model, when deployed to the vehicle, is configured to cause the vehicle to:
process real-time sensor data from one or more sensors of the vehicle; and
control a maneuver of the vehicle based on processing the real-time sensor data.

18. The vehicle of claim 17, wherein the control of the maneuver of the vehicle comprises generating a control signal to actuate at least one of a steering system, a braking system, or an acceleration system of the vehicle.

19. The vehicle of claim 11, wherein the operations further comprise projecting the LIDAR feature embeddings and the camera feature embeddings into the shared feature space using one or more projection heads prior to determining the prototype learning loss.

20. A computer-readable medium having instructions that, when executed by data processing hardware, causes the data processing hardware to perform operations comprising:
obtaining, from a Light Detection and Ranging (LIDAR) encoder, LIDAR feature embeddings based on LIDAR data for a three-dimensional (3D) scene;
obtaining, from a camera encoder, camera feature embeddings based on camera image data for the 3D scene;
generating, using a fusion encoder, fusion feature embeddings by fusing the LIDAR feature embeddings and the camera feature embeddings;
determining sampling weights for a plurality of points in the 3D scene based on a surface curvature estimated from the fusion feature embeddings, wherein points with higher surface curvature are assigned greater sampling weights;
selecting a subset of the plurality of points based on the sampling weights;
determining a rendering loss by performing differentiable rendering on the selected subset of points to reconstruct at least one of the LIDAR data or the camera image data;
determining a prototype learning loss by comparing the LIDAR feature embeddings and the camera feature embeddings to a set of learnable prototypes representing parts of the 3D scene in a shared feature space; and
jointly training the LIDAR encoder, the camera encoder, and the fusion encoder based on the rendering loss and the prototype learning loss.
